(19) United States
(12) Patent Application Publication
(10) Pub. No.: US 2008/0014355 A1
(43) Pub. Date: Jan. 17, 2008

(54) Method for Preparing a Palladium-Containing Layer

(75) Inventors: Kuei Jung Chao, Hsinchu City (TW); Chi Yuan Chang, Banciao City (TW); Wei Chih Lin, Kaohsiung City (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, Hsinchu (TW)

(21) Appl. No.: 11/457,128

(22) Filed: Jul. 12, 2006

(51) Int. Cl. B05D 3/04; B05D 3/02; B05D 1/36

(52) U.S. Cl. 427/304; 427/314; 427/404

(57) ABSTRACT

A method for preparing a palladium-containing layer comprises the steps of cleaning a top surface of the porous substrate, modifying the top surface of the porous substrate to form a planar surface, performing a seeding process on the planar surface to adhere palladium nanoparticles on the planar surface and performing an electroless plating process to form the palladium-containing layer on the planar surface. The step of modifying the top surface of the porous substrate includes filling holes of the porous substrate with aluminum oxide particles, coating a sol-gel containing aluminum oxide or silicon oxide on the top surface of the porous substrate, The step of performing a seeding process on the planar surface includes exposing the planar surface of the porous substrate in a nanocolloidal solution having dispersed palladium nanoparticles derived from a palladium-containing species and a surfactant.

### BACKGROUND OF THE INVENTION

(A) Field of the Invention

The present invention relates to a method for preparing a palladium-containing layer, and more particularly, to a method for preparing a palladium-containing layer on a porous substrate.

(B) Description of the Related Art

Hydrogen gas is a primary material for the fuel cell to generate energy. The use of hydrogen gas in the fuel cell in place of petroleum for energy generation not only provides high-energy transformation efficiency, but also solves the environmental problems such as pollutions and the greenhouse effect originating from the use of the petroleum. Nowadays, many automobile companies, such as Daimler Chrysler, Ford and General Motors, all try to fabricate cars using hydrogen gas fuel cell. Obviously, hydrogen gas is most likely to be a new energy source, and the hydrogen gas demand would be considerable in the near future.

Today's demand of hydrogen gas is high already. For example, the semiconductor industry needs hydrogen gas of high purity to perform the wafer fabrication, cleaning, and metal deposition processes. In addition, the petroleum industry needs hydrogen gas to decrease the sulfur content in the raw material to generate a high quality material. Furthermore, the synthesis of some elementary chemicals such as methanol and ammonia needs hydrogen gas also. Hydrogen gas can be produced from the steam reforming reaction of hydrocarbon or the electrolysis reaction of water, but the produced hydrogen gas needs to be further purified to meet the quality specification of different applications.

Fernando et al. discloses many hydrogen purification methods such as pressure swing adsorption (PSA), low-temperature distillation and membrane separation (see: Ind. Eng. Chem. Res. 2006, 45, 875). The membrane separation method is considered to be most popular in the future since it has some advantages such as easy operation, simple equipment requirement, low energy consumption and high efficiency, these complied with the requirements of low fabrication cost and small-scale fabrication. In particular, palladium or palladium alloy membrane only allows hydrogen to penetrate through via the solution-diffusion mechanism, and it has a very high efficiency on the hydrogen separation. The palladium and the palladium alloy membrane can be prepared by chemical vapor deposition, sputtering, electroplating and electroless plating, in which the electroless plating method is very simple and does not need expensive equipment, and the palladium and the palladium alloy membrane can be prepared on both conductive and non-conductive substrate.

Kikuchi et al. compared the palladium layers prepared on porous aluminum oxide substrate by the chemical vapor deposition method and the electroless plating method, respectively (see: Catal. Today 2000, 56, 75). They discovered that the hydrogen/nitrogen selectivity of the palladium layer prepared by the chemical vapor deposition is lower than that prepared by the electroless plating since the chemical vapor deposition cannot form a dense palladium layer. In particular, a methane transformer using the palladium layer prepared by the electroless plating will have a better transforming efficiency by.

Ma et al. discloses a method for preparing a defect-free palladium layer on a porous stainless steel (PSS) tube (see: AIChE, 1998, 44, 310). The disclosed method includes the steps of surface polishing, surface activation and electroless plating of palladium layer. In particular, they found that a core-palladium layer is formed on the surface of the PSS tube after the surface activation by alternative dipping in stannous chloride solution and in palladium chloride solution; the core-palladium layer is fragile and is likely to be peeled off. In other words, the adhesion between the core-palladium layer and the surface of the PSS tube is weak, and not suitable to practical applications. In addition, they also indicate that there are poles having sizes between 7 and 8 micrometers on the surface of the PSS tube after the surface polishing step, the thickness of the palladium layer must be larger than 30 micrometers (μm) to achieve defect-free layer, and the hydrogen permeability is only 2.77×10⁻⁴ mol/m²·s·Pa^{0.5}.

In U.S. Pat. No. 5,652,020, Collins et al. discloses a method for preparing a palladium layer on a porous aluminum oxide tube by electroless plating. The disclosed method uses stannous chloride solution and palladium chloride solution to sensitize the surface of the aluminum oxide tube, uses palladium chloride solution to activate the surface of the aluminum oxide tube, and uses electroless plating to form the palladium on the activated surface. However, the hydrogen/nitrogen selectivity is only 1000, and the thickness of the palladium layer must be larger than 10 μm to avoid the occurrence of defects.

Buxbaum et al. discloses a method for preparing a palladium layer in U.S. Pat. No. 6,461,408, U.S. Pat. No. 6,183,543, U.S. Pat. No. 5,931,987, U.S. Pat. No. 5,215,729, and U.S. Pat. No. 5,149,420. The method uses electrolysis technique to activate the surface of a supporter made of metals such as vanadium or niobium to form metal hydride on the surface of the supporter, and uses electroless plating technique to form the palladium layer. However, the method only can be applied to a certain metal supporter, and the hydrogen permeability decreases after high-temperature or long-term operation since the metal of the supporter diffuses into the palladium layer.

Fernando et al. indicates that the thicker of the palladium, the more expensive palladium, and the lower the hydrogen permeability (see: Ind. Eng. Chem. Res. 2006, 45, 875). Current development tendency of the palladium (or palladium alloy) coated tube is a super thin and continuous coated tube to maintain high hydrogen permeability and meet low cost consideration.

In short, the conventional technique for preparing the palladium layer activates the surface of the supporter by alternative dipping in stannous chloride solution and palladium chloride solution, but the prepared palladium layer tends to be fragile, peeling off and non-uniform due to the existence of stannous ions in the core-palladium layer on which the palladium layer is formed. Consequently, it is a challenge to prepare a dense palladium layer having a thickness below 10 micrometers, and having sufficient mechanical strength, defect-free, high hydrogen permeability and high hydrogen/nitrogen selectivity.

### SUMMARY OF THE INVENTION

The objective of the present invention is to provide a method for preparing a palladium-containing layer on a porous substrate, which possesses high hydrogen/nitrogen selectivity, high hydrogen permeability, high adhesion between the palladium-containing layer and the porous substrate.

A method for preparing a palladium-containing layer according to this aspect of the present invention comprises the steps of cleaning a top surface of the porous substrate such as a porous stainless steel (PSS) tube, modifying the top surface of the porous substrate to form a planar surface, performing a seeding process on the planar surface to adhere palladium nanoparticles on the planar surface and performing an electroless plating process to form the palladium-containing layer on the planar surface. The step of modifying the top surface of the porous substrate includes filling holes or concaves of the porous substrate with aluminum oxide particles, coating a sol-gel containing aluminum oxide or silicon oxide on the top surface of the porous substrate, and performing a thermal treating process.

The step of performing a seeding process on the planar surface includes exposing the planar surface of the porous substrate in a colloidal solution having dispersed palladium metal nanoparticles derived from palladium-containing species and a surfactant such that palladium seed is uniformly formed on the planar surface and the subsequent electroless plating process can form the palladium-containing layer thereon. The palladium-containing species can be either cations selected from the group consisting of palladium(II), triamminepalladium(II), and tetraamminepalladium(II), or anions selected from the group consisting of tetrachloropalladium(II), Amminetrichloropalladium(II), and 1,2-ethanediyl(dinitrilo) tetraacetatepalladium(II). The surfactant can be either anions selected from the group consisting of sodium tetradecylsulfate, sodium tridecylsulfate, sodium dodecylsulfate (SDS), sodium undecylsulfate, sodium decylsulfate, sodium nonylsulfate, and sodium octylsulfate, or cations selected from the group consisting of octadecyltrimethylammonium brombide, cetyltrimethylammonium brombide (CTAB), myristyltrimethylammonium brombide, dodecyltrimethylammonium brombide, cetyltrimethylammonium chloride, and dodecyltrimethylammonium chloride.

After the seeding process on the planar surface, it is preferable to expose the planar surface of the porous substrate in a complex ion solution including tetrachloropalladium(II) anions or tetraamminepalladium(II) cations to provide some palladium on the planar surface in advance. Then, an electroless plating process is conducted to expose the planar surface of the porous substrate in a plating solution having palladium-containing complex ions. It is preferably to expose the bottom surface of the porous substrate in an ion-containing solution having an ion concentration higher than the ion concentration of the plating solution during the electroless plating process. In addition, a thermal treating process after the electroless plating process is preferably performed in an inert atmosphere such as nitrogen, argon, etc and in a mixture atmosphere of hydrogen and inert gas in sequence.

### BRIEF DESCRIPTION OF THE DRAWINGS

The objectives and advantages of the present invention will become apparent upon reading the following description and upon reference to the accompanying drawings in which:

FIG. 1 to FIG. 4 illustrate a method for preparing a palladium-containing layer on a porous substrate according to one embodiment of the present invention;

FIG. 5 shows TEM image and PXRD plot of the palladium nanoparticles according to one embodiment of the present invention;

FIG. 6 shows the argon flow rate (F) from the inner hollow portion via the PSS tube body to the outer environment before and after the surface-modifying process according to an embodiment of the present invention;

FIG. 7 shows the argon permeability of the PSS tube having the palladium-containing layer according to an embodiment of the present invention;

FIG. 8 shows the variation of concentrations of Pd(II) ions in the plating solutions with time during the electroless plating process; and

FIG. 9 shows the thermal history of the palladium-containing layer on the porous substrate for the hydrogen purification process according to an embodiment of the present invention.

### DETAILED DESCRIPTION OF THE INVENTION

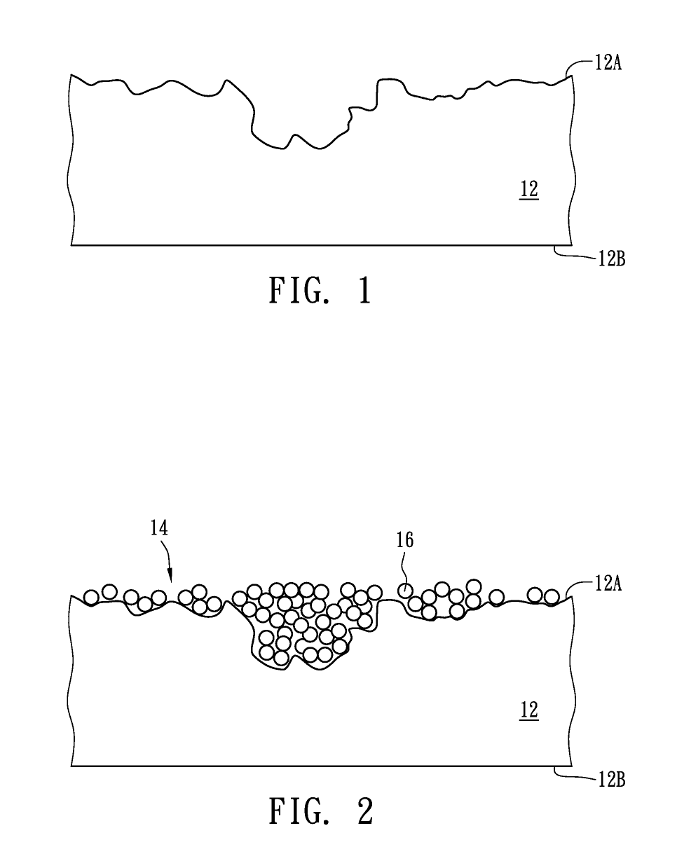

FIG. 1 to FIG. 4 illustrate a method for preparing a palladium-containing layer 10 on a porous substrate 12 according to an embodiment of the present invention. First, a cleaning process is performed to clean a top surface 12A of the porous substrate 12, e.g., a porous stainless steel tube, using a cleaning solution selected from the group consisting of de-ionized (DI) water, organic solvent, acidic solvent, alkaline solvent, and the combination thereof. Ultrasonic wave clean may be further applied to the cleaning process. The cleaned porous substrate 12 is then dried in an oven.

Referring to FIG. 2, a surface-modifying process is performed on the top surface 12A of the porous substrate 12 to form a planar surface 14 by filling holes or concaves of the porous substrate 12 with aluminum oxide particles 16 having particle sizes about 0.5 μm, and coating a sol-gel containing aluminum oxide or silicon oxide on the top surface 12A of the porous substrate 12. A thermal treating process is performed at a temperature between 350° C. and 550° C. to transform the sol-gel into the aluminum oxide (or silicon oxide) particles 16.

Referring to FIG. 3, a seeding process is performed on the planar surface 14 to adhere palladium nanoparticles 18 on the planar surface 14. The seeding process may include exposing the planar surface 14 of the porous substrate 12 in a colloidal solution having dispersed palladium nanoparticles 18. The dispersed palladium particles 18 can be derived from a palladium-containing species and a surfactant with/without a reducing reagent. The reducing reagents can be ethanol, alcohol, hydrazine and sodium borohydride

The palladium-containing species can be either cations selected from the group consisting of palladium(II), triamminepalladium(II), and tetraamminepalladium(II), or anions selected from the group consisting of tetrachloropalladium(II), Amminetrichloropalladium(II), and 1,2-ethanediyl(dinitrilo) tetraacetatepalladium(II). The surfactant can be either anions selected from the group consisting of sodium tetradecylsulfate, sodium tridecylsulfate, sodium dodecylsulfate (SDS), sodium undecylsulfate, sodium decylsulfate, sodium nonylsulfate, and sodium octylsulfate, or cations selected from the group consisting of octadecyltrimethylammonium brombide, cetyltrimethylammonium brombide (CTAB), myristyltrimethylammonium brombide, dodecyltrimethylammonium brombide, cetyltrimethylammonium chloride, and dodecyltrimethylammonium chloride.

If the surfactant is anionic, it is preferable to adjust the pH value of the colloidal solution to be lower than 7, e.g., pH=2. The aluminum oxide particles 16 are positively charged at pH=2, and the anionic surfactant carrying palladium is attracted by the positively charged aluminum oxide particles 16 to the planar surface 14. Furthermore, If the surfactant is cationic, it is preferable to adjust the pH value of the colloidal solution to be higher than 7, e.g., pH=12. The aluminum oxide particles 16 are negatively charged at pH=12, and the cationic surfactant carrying palladium is attracted by the negatively charged aluminum oxide particles 16 to the planar surface 14.

As such, the palladium is transferred from the colloidal solution to the planar surface by electrostatic force in the seeding process. Preferably, a pressure difference between the top surface 12A and a bottom surface 12B of the porous substrate 12 is generated during the seeding process to improve the mass-transferring efficiency from the colloidal solution to the seeding surface, and the pressure at the top surface 12A is higher than the pressure at the bottom surface 12B.

After the seeding process on the planar surface, it is preferable to expose the planar surface 14 of the porous substrate 12 in a complex ion solution including tetrachloropalladium(II) anions (PdCl₄²⁻) or tetraamminepalladium(II) cations (Pd(NH₃)₄²⁺). The complex ion solution can provide some palladium atoms on the planar surface 14 in advance, and these palladium atoms serve as reactant in the subsequent electroless plating process. Consideration to the electrostatic attraction effect in mass-transferring process, it is preferable to use the complex ion solution including tetraamminepalladium(II) cations (Pd(NH₃)₄²⁺) if the surfactant is anionic, and use the complex ion solution including tetrachloropalladium(II) anions (PdCl₄²⁻) if the surfactant is cationic.

Referring to FIG. 4, an electroless plating process is performed at 60° C. for 2 hours so as to form the palladium-containing layer 10 on the planar surface 14. The plating solution may include PdCl₂, NH₄OH, EDTA·2Na, and N₂H₄. In particular, the electroless plating process may be an osmosis electroplating process, which exposes the planar surface 14 of the porous substrate 12 in the plating solution and exposes the bottom surface 14B of the porous substrate 12 in a solution having an ionic or molecular concentration higher than the ion concentration of the plating solution employed in the electroless plating process. In addition, metal ion such as silver ion may be added in the electroplating solution such that the palladium-containing layer 10 could be a palladium alloy layer.

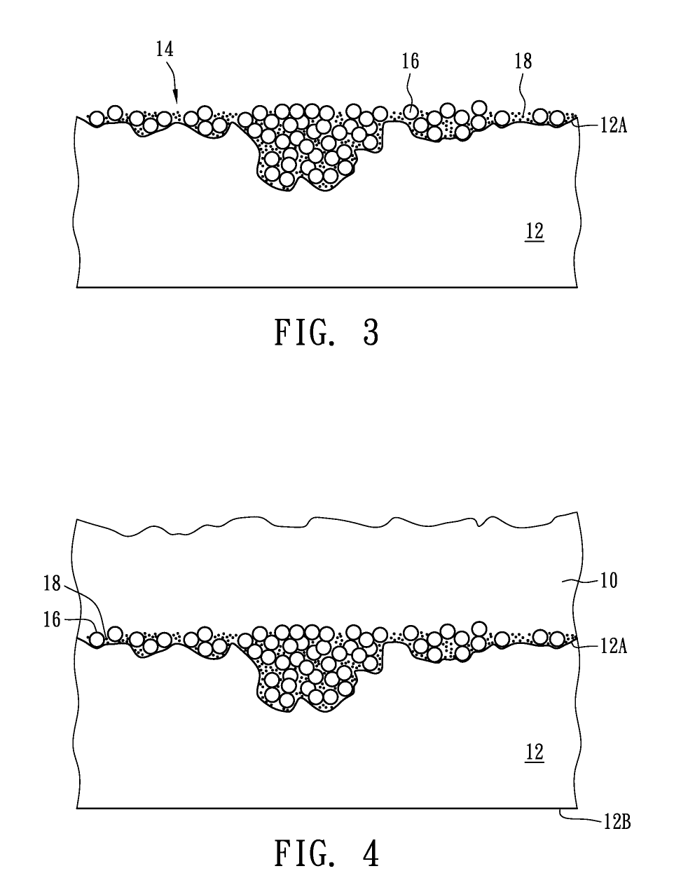

FIG. 5 shows Transmission Electron Microscope (TEM) image and Powder X-ray Diffraction (PXRD) plot of the palladium nanoparticles 18 according to one embodiment of the present invention. The palladium nanoparticles 18 can be prepared using different reactants such as Pd(OAc)₂+SDS, PdCl₂+CTAB+N₂H₄, and HPdCl₃+SDS. The TEM image is used to estimate the sizes of the palladium nanoparticles 18, and the PXRD analysis is used to characterize the palladium nanoparticles 18, as shown in the following table. Obviously, the palladium nanoparticles 18 prepared by Pd(OAc)₂+SDS have two size groups of about 2˜4 nm and 10˜30 nm.

| | Particles size(nm) by |
|---|---|
| Synthesis reactant | TEM |
| Pd(OAc)₂ + SDS | 10~30 & 2~4 |
| PdCl₂ + CTAB + N₂H₄ | 4~7 (FIG. 5) |
| HPdCl₃ + SDS | 10~25 |

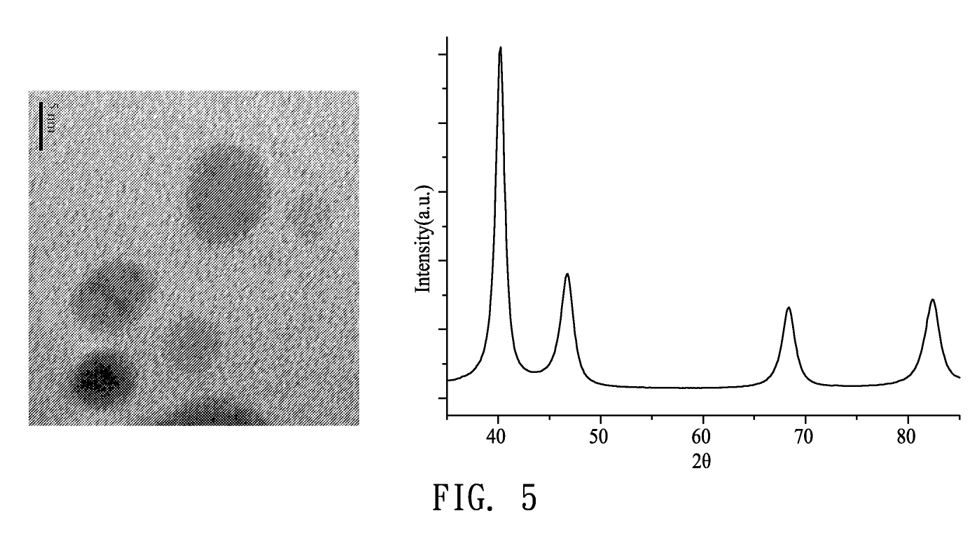

FIG. 6 shows the argon (Ar) flow rate (F) from the inner hollow portion via the PSS tube body to the outer environment before and after the surface-modifying process according to an embodiment of the present invention. The surface-modifying process is performed in two ways: (1) the holes or concaves are filled with aluminum oxide and coated with aluminum oxide sol-gel (PSS\Al₂O₃\cAl₂O₃) thereon; (2) the holes or concaves are filled with aluminum oxide and coated with silicon oxide sol-gel (PSS\Al₂O₃\cSiO₂). The argon flow rate of the PSS tube without undergoing surface-modifying process is higher that these of undergoing surface-modifying process. In addition, the argon flow rate of the PSS tube with silicon oxide sol-gel coating is higher than that with aluminum oxide sol-gel coating. In other words, the surface-modifying process using aluminum oxide filling and aluminum oxide coating has a better hole-filling (or concave-filling) ability.

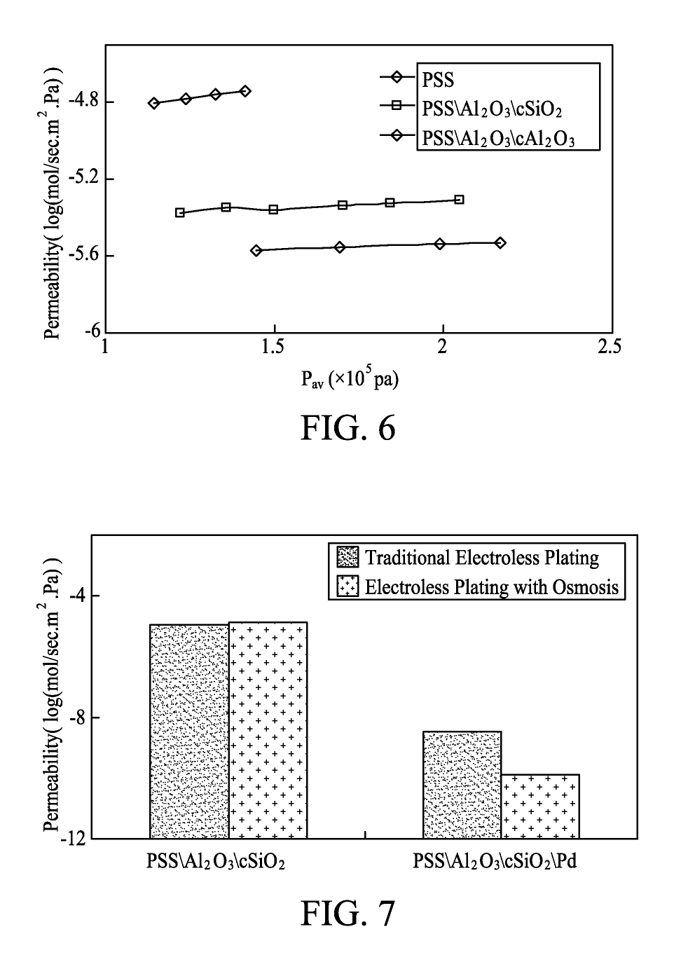

FIG. 7 shows the argon permeability of the PSS tube having the palladium-containing layer 10 according to an embodiment of the present invention. The argon permeability of palladium-containing layer 10 prepared by traditional electroless plating process is much larger than that prepared by the electroless plating process with osmosis, i.e., the number of pin-holes in the palladium-containing layer 10 prepared by the electroless plating process with osmosis is fewer than that prepared by the simple electroless plating process without osmosis.

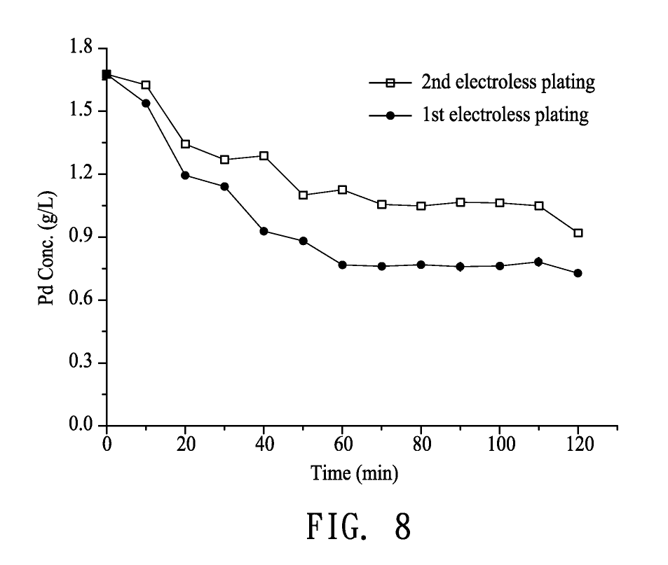

FIG. 8 shows variation of the Pd(II) ions concentration in the electroless plating solution. The electroless plating process is performed twice. The rate of Pd(II) ions consumed in a first electroless plating process right after the activation process, i.e., the seeding process, is much faster than that in a second electroless plating process, which is subsequent to the first electroless plating process. The variation of the Pd(II) ions concentration indicates that the rate of palladium deposition is significantly enhanced by the activation process according to the present invention.

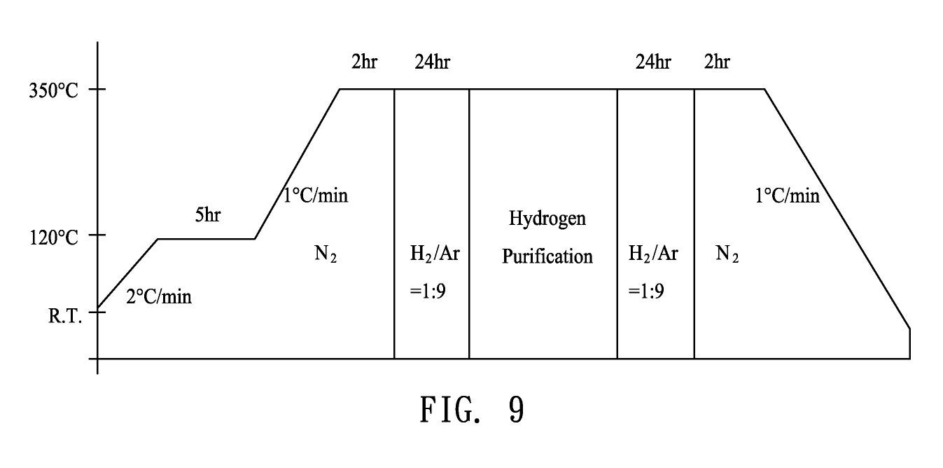

FIG. 9 shows the thermal history of the palladium-containing layer 10 on the porous substrate 12 for the hydrogen purification process according to an embodiment of the present invention. Before the hydrogen purification process performs at about 350° C., a thermal treating process is preferably performed in an inert atmosphere such as nitrogen, argon, etc and in a mixture atmosphere of hydrogen and inert gas in sequence. In addition, it is also preferable to perform another thermal treating process in a mixture atmosphere of hydrogen and inert gas and in an inert atmosphere in sequence after the hydrogen purification process.

The hydrogen/nitrogen selectivity of the palladium-containing layer 10 is shown in the following table, and it is obvious the hydrogen/nitrogen selectivity of the palladium-containing layer 10 operating in accordance with the thermal history shown in FIG. 9 is higher than 6000. In particular, the thermal history may includes the processes of placing the porous substrate 12 having the palladium-containing layer 10 in a container containing nitrogen at a predetermined temperature, transferring a mixture gas containing hydrogen and argon into the container, transferring hydrogen into the container to actually perform the hydrogen purification process, transferring the mixture gas into the container, transferring nitrogen into the container and reducing the temperature in the container.

| | Hydrogen flow | Nitrogen flow | |
|---|---|---|---|
| Test number | rate (ml/min) | rate (ml/min) | Selectivity |
| 1 | 181.1 | 0.03 | 6037 |
| 2 | 215.1 | 0.03 | 7170 |
| 3 | 225.0 | 0.03 | 7499 |
| 4 | 224.7 | 0.03 | 7490 |
| 5 | 232.9 | 0.03 | 7762 |

1 mL/min = 4.5 × 10⁻⁴ mol/m² · s = 2.6 × 10⁻⁶ mol/m² · s · Pa^{0.5}

The above-described embodiments of the present invention are intended to be illustrative only. Numerous alternative embodiments may be devised by those skilled in the art without departing from the scope of the following claims.

What is claimed is:

1. A method for preparing a palladium-containing layer on a porous substrate, comprising the steps of:
cleaning a top surface of the porous substrate;
modifying the top surface of the porous substrate to form a planar surface;
performing a seeding process on the planar surface to adhere palladium nanoparticles on the planar surface; and
performing an electroless plating process to form the palladium-containing layer on the planar surface.

2. The method for preparing a palladium-containing layer on a porous substrate of claim 1, wherein the step of cleaning the top surface of the porous substrate uses a cleaning solution selected from the group consisting of water, organic solvent, acidic solvent, alkaline solvent, and the combination thereof.

3. The method for preparing a palladium-containing layer on a porous substrate of claim 1, wherein the step of modifying the top surface of the porous substrate includes:
filling holes of the porous substrate with aluminum oxide particles;
coating a sol-gel on the top surface of the porous substrate; and
performing a thermal treating process to form the planar surface.

4. The method for preparing a palladium-containing layer on a porous substrate of claim 3, wherein the sol-gel includes aluminum oxide or silicon oxide.

5. The method for preparing a palladium-containing layer on a porous substrate of claim 1, wherein the step of performing a seeding process on the planar surface includes exposing the planar surface of the porous substrate in a colloidal solution having dispersed palladium nanoparticles.

6. The method for preparing a palladium-containing layer on a porous substrate of claim 5, wherein the dispersed palladium nanoparticles are derived from a palladium-containing species and a surfactant.

7. The method for preparing a palladium-containing layer on a porous substrate of claim 6, wherein the palladium-containing species is cations selected from the group consisting of palladium(II), triamminepalladium(II), and tetraamminepalladium(II).

8. The method for preparing a palladium-containing layer on a porous substrate of claim 6, wherein the palladium-containing species is anions selected from the group consisting of tetrachloropalladium(II), Amminetrichloropalladium(II), and 1,2-ethanediyl(dinitrilo) tetraacetatepalladium(II).

9. The method for preparing a palladium-containing layer on a porous substrate of claim 6, wherein the surfactant is anions selected from the group consisting of sodium tetradecylsulfate, sodium tridecylsulfate, sodium dodecylsulfate, sodium undecylsulfate, sodium decylsulfate, sodium nonylsulfate, and sodium octylsulfate.

10. The method for preparing a palladium-containing layer on a porous substrate of claim 6, wherein the surfactant is cations selected from the group consisting of octadecyltrimethylammonium brombide, cetyltrimethylammonium brombide, myristyltrimethylammonium brombide, dodecyltrimethylammonium brombide, cetyltrimethylammonium chloride, and dodecyltrimethylammonium chloride.

11. The method for preparing a palladium-containing layer on a porous substrate of claim 6, wherein the dispersed palladium nanoparticles are derived from a palladium-containing species and a surfactant with a reducing reagent, and the reducing reagent is selected from the group consisting of ethanol, alcohol, hydrazine and sodium borohydride.

12. The method for preparing a palladium-containing layer on a porous substrate of claim 1, wherein the step of performing a seeding process on the planar surface includes generating a pressure difference between the top surface and a bottom surface of the porous substrate.

13. The method for preparing a palladium-containing layer on a porous substrate of claim 12, wherein the pressure at the top surface is higher than the pressure at the bottom surface.

14. The method for preparing a palladium-containing layer on a porous substrate of claim 1, further comprising a step of exposing the planar surface of the porous substrate in a complex ion solution after the step of performing a seeding process on the planar surface.

15. The method for preparing a palladium-containing layer on a porous substrate of claim 14, wherein the complex ion solution includes tetrachloropalladium(II) anions or tetraamminepalladium(II) cations.

16. The method for preparing a palladium-containing layer on a porous substrate of claim 1, wherein the step of performing an electroless plating process includes exposing the planar surface of the porous substrate in a plating solution having palladium-containing complex ions.

17. The method for preparing a palladium-containing layer on a porous substrate of claim 17, wherein the step of performing an electroless plating process further includes exposing the bottom surface of the porous substrate in an ion-containing solution having an ion concentration higher than the ion concentration of the plating solution.

18. The method for preparing a palladium-containing layer on a porous substrate of claim 1, further comprising a step of performing a thermal treating process in an inert atmosphere or in a mixture of hydrogen and an inert gas after the electroless plating process.

19. The method for preparing a palladium-containing layer on a porous substrate of claim 18, wherein the inert gas is selected from the group consisting of nitrogen, argon, and helium.

20. The method for preparing a palladium-containing layer on a porous substrate of claim 18, wherein the step of performing a thermal treating process includes:
placing the porous substrate having the palladium-containing layer in a container containing the inner gas at a predetermined temperature;
transferring a mixture gas containing hydrogen and the inert gas into the container;
transferring hydrogen into the container;
transferring the mixture gas into the container; and
transferring inert gas into the container and reducing the temperature in the container.
